(19) United States
(12) Patent Application Publication
(10) Pub. No.: US 2010/0009614 A1
(43) Pub. Date: Jan. 14, 2010

(54) METHOD FOR AUTOMATIC CUTTING OF HAMS, AND AN APPARATUS FOR AUTOMATIC CUTTING OF HAMS

(76) Inventors: Finn Hansen, Greve (DK); Lars Ror-baek-olsson, Humleaek (DK)

Correspondence Address: MARSHALL, GERSTEIN & BORUN LLP, 233 SOUTH WACKER DRIVE, 6300 SEARS TOWER, CHICAGO, IL, 60606-6357, US

(21) Appl. No.: 12/306,051

(22) PCT Filed: Jun. 20, 2007
(86) PCT No.: PCT/DK07/00299

§ 371 Date: Jul. 27, 2009

(30) Foreign Application Priority Data
Jun. 21, 2006 (DK) PA 2006 00839

(51) Int. Cl. A22C 17/00

(52) U.S. Cl. 452/154

(57) ABSTRACT

A method and an apparatus for automatic cutting of hams, with the hams conveyed on a first conveyor inwards below and to engagement with a carrier for the pubic bone of the ham, which is held by the carrier. The ham is conveyed further on by a second conveyor and an overhead conveyor for the carrier with the rind side lying on the second conveyor, where the pubic bone is pressed by a spring force against and is held by the carrier in a predetermined, vertical position. Cutting devices for the cutting of the hams are arranged at these conveyors. This apparatus and method makes it possible to position the hams precisely relative to the cutting tools which are to process tailbone, groin meat, groin fat and fat edge, irrespective of the sizes of the hams, owing to the engagement of the pubic bone with the carrier.

### CROSS-REFERENCE TO RELATED APPLICATION

The present application claims the benefit of priority of International Patent Application No. PCT/DK2007/000299, filed Jun. 20, 2007 which application claims priority of Danish Patent Application No. PA 2006 00839, filed Jun. 21, 2006. The entire text of the priority application is incorporated herein by reference in its entirety.

### FIELD OF THE DISCLOSURE

The disclosure relates to a method and apparatus for automatic cutting of hams.

### BACKGROUND

Normally, raw hams are round-cut in that 2-5 operators manually break off the tailbone from the collarbone and remove the tailbone from the ham. In addition, the groin meat, the groin fat and a fat edge are cut off. Other processing may also be required.

These processes are quite time-consuming and labour-intensive.

EP 0 882 404 A2 discloses an apparatus for automatic cutting of hams, wherein the hams are fed on a conveyor which have holding means for holding the hams during their feeding toward a cutting station, where bones are removed from the hams.

### SUMMARY OF THE DISCLOSURE

One aspect of the disclosure is to enable further automatization of one or more of the cutting processes with respect to hams, which not only comprises boning of the ham, but also removal of groin meat, groin fat and fat edge, which requires accurate positioning of the hams before they are passed on for the processing proper, thus allowing rationalization and improvement of the working environment to be achieved.

One aspect of the disclosure is achieved by a method according to the disclosure, including the following:

a) a ham is conveyed with the rind side lying on a first conveyor inwards below a carrier for the pubic bone of the ham,

b) the pubic bone is caused to engage the carrier and is moved to a predetermined position in which the pubic bone is pressed up against the carrier and is held by it,

c) the ham is conveyed by a second conveyor and an overhead conveyor for the carrier with the rind side lying on the second conveyor and the pubic bone pressed up against and held by the carrier to an area, where cutting tools are arranged at these conveyors for the cutting of the ham.

Hereby, the ham may be fixed with the pubic bone in a predetermined position and be transported in a predetermined manner, so that the cutting tools may perform one or more of the cutting processes when the hams are in position, e.g. remove tailbone and groin meat.

An essential feature of the disclosure is that the method allows the ham to be positioned vertically and horizontally, so that, owing to the engagement between the pubic bone and the carrier, it is positioned precisely, irrespective of the size, relative to tools for the processing of tailbone and other ham parts.

According to an embodiment, the carrier may be moved upwards against a spring force to a stop abutment in a predetermined, vertical position.

The carrier may comprise a backstop part for contact with the upper side of the pubic bone, and a hanger part which holds the pubic bone transversely and rearwardly relative to the transport direction.

Expediently, step c) is implemented, as stated in claim 2, by comprising one or more of the following steps:

d) the tailbone is separated from the collarbone by means of a knife, which is moved in the transport direction of the conveyor and of the carrier during the separation, e.g. a knife mounted on a carriage.

e) the tailbone is undercut from the musculature of the ham by a rotatable curved knife, which is moved in the transport direction of the conveyor and of the carrier, e.g. a knife mounted on a carriage,

f) a fat edge is cut off in the transport movement by a knife, which is arranged stationarily or movably,

g) the groin meat is gripped by a gripper, which pulls the groin meat at the same time as a knife cuts the groin meat.

Since the method according to the disclosure is to be able to handle both right and left hams, it will be an advantage that prior to the introduction into the first conveyor in step a), the hams are conveyed on a conveyor belt with their cut face in parallel with the transport direction of the conveyor belt, and that, prior to the entry into the conveyor in step a) the hams are turned by a pawl, which is capable of assuming two positions and is moved perpendicularly inwards from the side of the conveyor belt, and which turns the hams so that the cut face will be disposed rearmost in the transport direction.

It is expedient that the carriers are moved by means of an annular chain path, carriage or other conveyor in the same direction as the transport direction of the second conveyor, so that the ham is held between this and the carrier while being transported to and through the cutting area.

Additionally, it is expedient, as stated in claim 7, that the movement in step b) to a predetermined position, in which the pubic bone is pressed up against the carrier, may be established in that the ham is moved up an inclined introduction belt, which is spring-loaded upwards by a greater force than the downwardly directed forces.

Thus, by moving the ham up an inclined introduction belt, which is e.g. defined by side walls, it is possible to move the ham so that the pubic bone affects the carriers in an upward direction, and the pubic bone is stopped in a predetermined position, irrespective of the size of the supplied hams. Further, the x-, y-positions of the cut faces of all the hams will be uniform.

As mentioned, the disclosure also relates to an apparatus for automatic cutting of hams. This apparatus is characterized by comprising the following parts:

a) a first conveyor for supporting the ham on the rind side and for conveying it inwards below a carrier for the pubic bone of the ham,

b) devices for engaging the pubic bone with the carrier and moving the pubic bone up to a predetermined position, in which the pubic bone is pressed up against the carrier and is held by it, and

c) a second conveyor for supporting the ham on the rind side and an overhead conveyor for the carrier extending along the second conveyor, whereby cutting tools are arranged at an area of these conveyors.

### BRIEF DESCRIPTION OF THE DRAWINGS

The disclosure will be now be explained more fully with reference to the drawing, in which

FIG. 1 shows the basic structure of a system for performing the method according to the disclosure,

FIG. 2 shows how a ham is positioned on a roller path,

FIG. 3 shows a ham positioned on the roller path of FIG. 2,

FIG. 4 shows a spring-loaded pubic bone hanger for fixing the ham against the roller path,

FIG. 5 shows an inclined introduction belt arranged in extension of the roller path of FIG. 1 and FIG. 2,

FIG. 6 shows a tool for cutting off the tailbone from the collarbone in the cartilage joint between these,

FIG. 7 shows the function of the tool of FIG. 6,

FIG. 8 shows a tool for cutting off the tailbone from the ham,

FIG. 9 shows parts of the tool of FIG. 8 seen from the opposite end,

FIG. 10 shows a tool for cutting off a fat edge, while

FIG. 11 shows a tool for cutting off groin meat on the ham.

### DETAILED DESCRIPTION OF THE PREFERRED EMBODIMENT

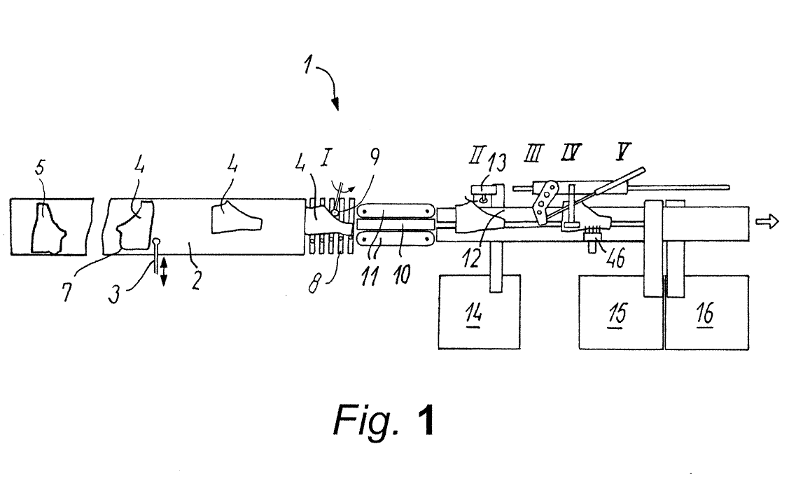

In FIG. 1, the numeral 1 generally designates a system for the round-cutting of hams using the method and the apparatus according to the disclosure.

From a cutting system (not shown) for tripartition of half pig carcases, left hams and right hams 5 are conveyed into a conveyor belt 2, where they are turned by a means of movable pawl 3 so as to be disposed with their cut face 7 rearmost in the direction of movement of the conveyor belt.

The hams are conveyed from the conveyor belt 2 into the system, which is formed by five sections designated I IV, respectively. The order of sections II to V maybe different from that shown in the figure, if so desired.

The shown sections II to V and their tools are intended for the processing of right hams. Tools for the processing of left hams may be arranged in the same sections II to V, or corresponding sections may be arranged after the shown sections II to V, where the tools are adapted to the processing of left hams. An option is to construct a system for right hams and a system for left hams, thereby avoiding the pawl 3.

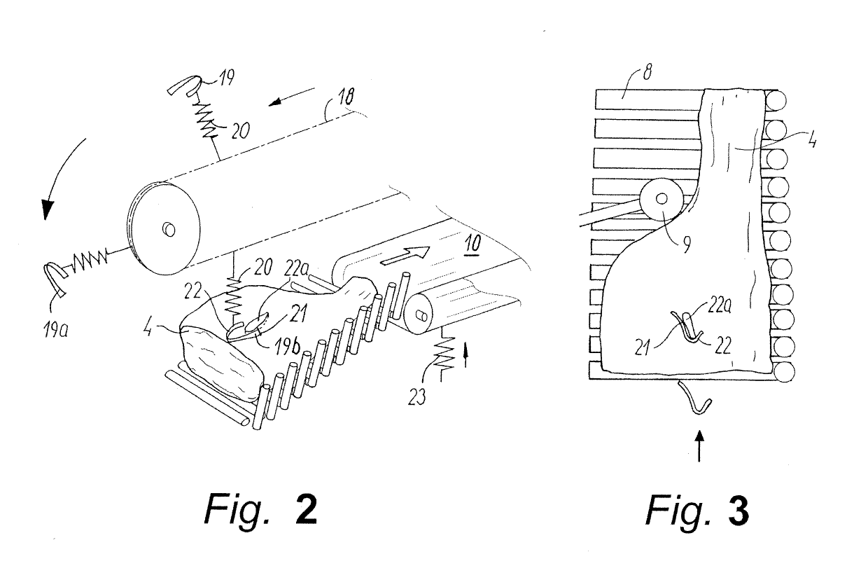

Section I comprises an overhead conveyor with carriers for the pubic bones of the hams and a roller belt 8 (i.e., a roller conveyor formed of several consecutive rollers each with its own fixed axis, with both horizontally- and vertically-aligned rollers—see FIGS. 2 & 3), and having a stop device 9. The function will be explained in connection with FIG. 2.

An inclined conveyor belt 10 is arranged between the sections I and II. The function will be explained in connection with FIG. 5.

The sections II-IV comprise cutting tools and a spring-loaded conveyor belt 12. In section II, a tool cuts a fat edge, if any, of supplied hams as well as tails which are transferred to a vessel 14; that is, the tool cuts off the tail and any possible fat edge, and then they are transferred to the vessel 14.

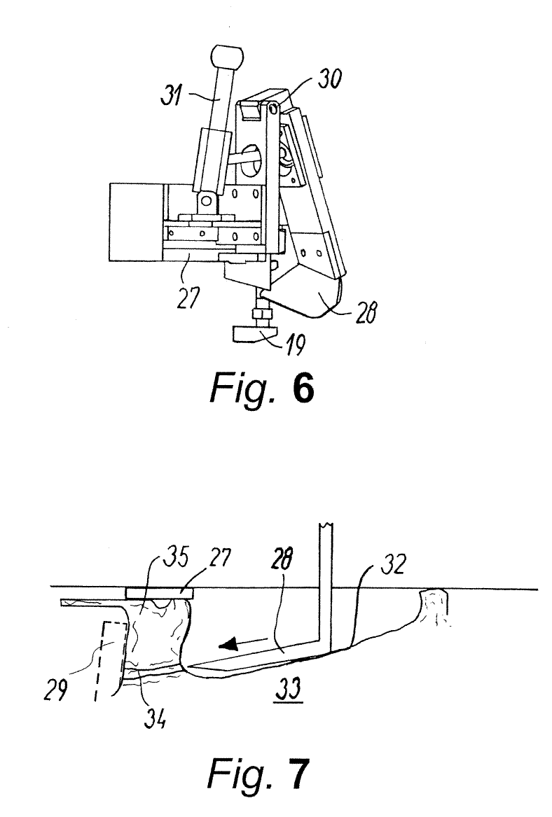

In section III, the tailbone is detached from the collarbone, cf. the explanation in connection with FIGS. 6 and 7.

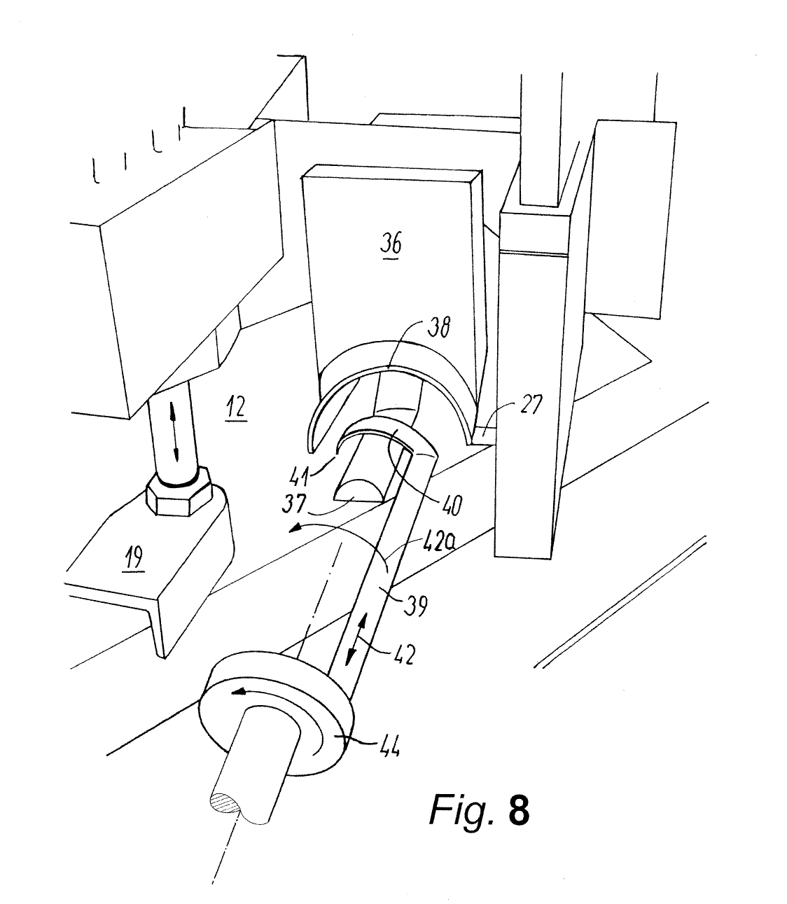

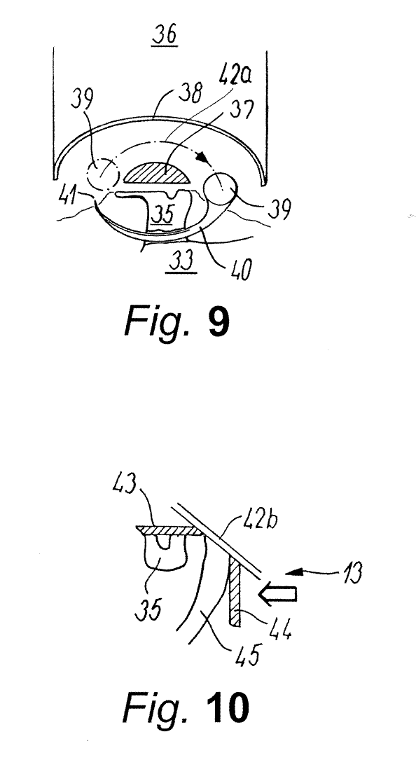

In section IV, the tailbone is cut off from the ham, cf. the explanation in connection with FIGS. 8 and 9, and is transferred to a vessel 15.

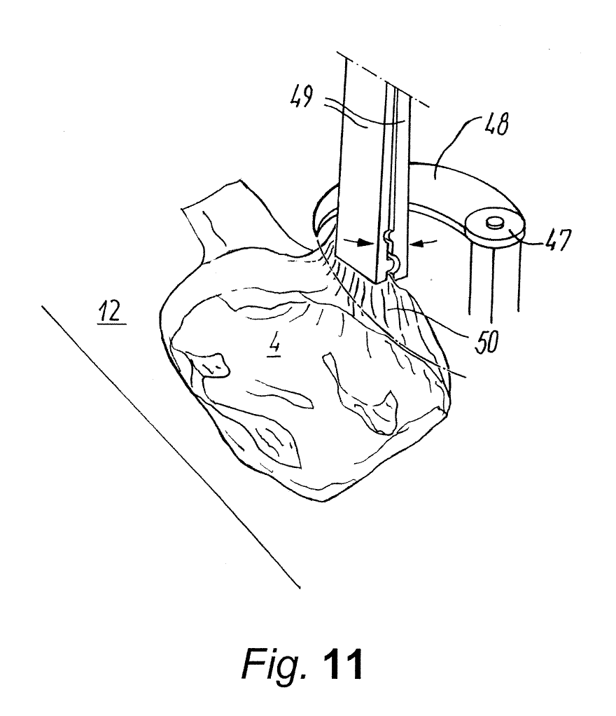

In section V, the groin meat is cut off, as explained in connection with FIG. 11.

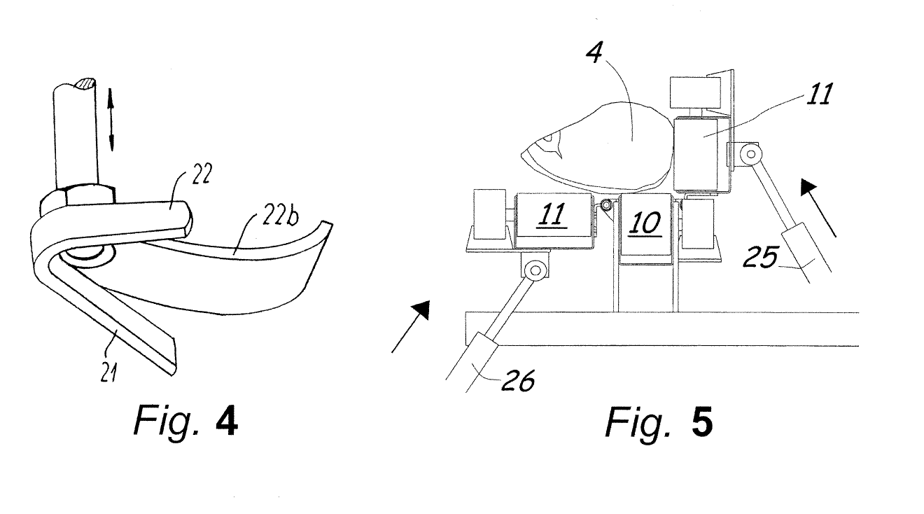

With reference now to FIGS. 2-5, it will be explained how hams are positioned on the roller path.

When the ham reaches the end of the roller conveyor 8, it is stopped by an arm, at whose free end a wheel 9, which holds the ham on the roller conveyor 8, is mounted.

Then, a circulating chain conveyor 18 (i.e., formed as a chain conveyor with an endless chain running on wheels with a number of gripping carrier devices respectively fastened to some of the chain links—see FIG. 2) moves a carrier 19 for a pubic bone 22a by means of a fixed closed circuit chain path (i.e., the endless chain moving in a closed-circuit path), which extends—see dot-dash lines as shown in FIG. 2, in the direction of the curved arrow from the position 19 to the positions 19a and 19b, where the carrier grips the pubic bone with gripper parts 21, 22.

The carrier 19 is connected with the conveyor 18 by means of a spring 20, so that a horizontal contact face between the gripper parts 21, 22 presses down against the pubic bone after contact has been made, and the carrier 19 can yield to an upwardly directed movement of the ham.

Many such carriers 19 are arranged on the circulating chain conveyor 18 at a distance corresponding to the one in which the hams are to be processed in the system.

Then, the ham is moved into a spring-suspended introduction belt 10, which extends obliquely upwards from the path of the roller conveyor 8, and which has a swingable conveyor belt 11 along each side. The swinging movement of the conveyor belts is provided by linear actuators, e.g. pneumatic or hydraulic working cylinders 25, 26.

The movement up the inclined introduction belt 10 causes the spring of the carrier to be compressed until the movement is stopped by a stop in the carrier, whereby the Z-position of the pubic bone 22a is determined. This position is maintained during the further course, as the ham is pressed up by the conveyor belts.

When the ham arrives at the end of the conveyor belt 10, it will be pressed down to a horizontal position, so that the downstream part is at a level which substantially corresponds to the level of the upstream part of the subsequent, spring-loaded conveyor belt 12.

In addition, the swingable conveyor belts 11 will ensure that the meat parts of the hams are arranged uniformly, so that they will be positioned correctly relative to the subsequent processing tools.

Which of the conveyors 11 provides a movement, depends on whether a right or left ham is introduced onto the inclined conveyor belt.

The ham is conveyed from the inclined conveyor belt onto the horizontal conveyor belt 12, which is spring-loaded and presses the ham upwards against the carrier.

Depending on whether a large or small ham is involved, the springs of the horizontal conveyor belt will be compressed more or less. The uppermost point of the pubic bone of the ham will always have the same Z-coordinate, which is decisive to ensure that the subsequent processing tools assume a correct position relative to the parts of the ham which are to be processed.

A fat edge is cut off by a knife instrument 13 on the horizontal conveyor belt in section 11, cf. FIG. 1.

The ham is conveyed by the horizontal conveyor belt to a tool which is adapted to break the joint, which consists of cartilage, between the tailbone and the collarbone. The tool, cf. FIG. 6 and FIG. 7, consists of a backstop part 27, a pair of scissors 28 and a rear knife 29, said pair of scissors 28 being swingable about a shaft 30 by the operation of a release arm 31 which is activated by a curved rail. The backstop part 27 is reciprocated by means of a curved rail. The knife 28 is provided with a bevelled cutting edge.

As will be seen best in FIG. 7, the pair of scissors operates in that the tailbone 35 is pressed up against the backstop 27 and the holding part, the rear knife 29 is moved inwards along the side of the tailbone 35, following which the knife 28 is pressed down against the bottom 32 of the collarbone 33 so that its cutting edge is positioned at the cartilage layer 34 between the tailbone 35 and the collarbone 33.

When the pair of scissors is closed subsequently, the knife 28 will cut through the cartilage layer 34 between the tailbone 35 and the collarbone 33.

The ham is conveyed to the area IV with the pubic bone pressed up against the contact face of the carrier on the horizontal conveyor belt 12, where the tailbone is detached from the ham by means of a tool, which will be described in connection with FIGS. 8 and 9.

The tool is formed by a fixture 36 having a backstop 37, where the ham with the tailbone (not shown in the figures) is placed. A curved knife 40 having a knife tip 41 is secured at its one end to a shaft 39, which may be displaced in the longitudinal direction as indicated by the arrow 42 and be rotated round the backstop as indicated by the arrow 42a. In a direction opposite to the curved knife, the shaft is secured to an eccentric 44. A bearing 38 may serve to support the knife.

The tool operates in the following manner:

The tailbone 35 and the collarbone 33 detached from it, cf. FIG. 9, are disposed below the backstop 37.

The curved knife is now moved axially through the fixture, where the meat between the backstop 37 and the bearing 38 is to be cut free. When the curved knife has been moved completely into the fixture to a position where it reaches the point on the tailbone where it meets the collarbone, the curved knife is rotated so that it cuts free the meat below the tailbone and hits the cartilage joint between the tailbone 35 and the collarbone 33.

Then, the curved knife 40 is pulled back, whereby the tailbone is detached completely from the ham and may be transferred to the vessel 15, cf FIG. 1.

After this operation, a fat edge 45 is removed, cf FIG. 10, in that the fat edge is held between two guide members 43, 44 and is cut by a knife 42b. The member 43 is hereby pressed against the side of the ham and follows its curvature, so that the inclined cutting of the fat edge is uniform in the length of the ham.

After the above operations, the ham is conveyed to the area V where the groin meat 50 is to be removed.

Before this takes place, the upper side of the groin meat is affected by a brush, which is designated 46 in FIG. 1, as a result of which the subsequent operation is easier to perform.

This operation is illustrated in FIG. 11, and, as will be seen, the groin meat 50 is gripped. The ham is still present on the spring-loaded conveyor belt, pressed up against the carrier. A gripper 49 pulls the groin meat upwards.

Then, a knife 48 is activated by a motor 47, which imparts a rotary movement to the knife so that the groin meat is cut free along the dot-and-dash line shown. The groin meat may easily be cut off by this method, as it hangs in membranes which are exposed by the pull of the meat. After the cutting, the groin meat is transferred to a vessel 16.

The tools in the areas III and IV are mounted on a carriage, which is moved along the conveyor belt at the speed of the belt, so that the cutting functions may be performed as if the hams were stationary relative to the tools. The synchronization takes place by means of the positions of the carriers, which define the current position of the pubic bone. We claim:

1. A method for automatic cutting of hams, comprising:
a) conveying a ham with the rind side lying on a first conveyor inwards below a carrier for the pubic bone of the ham,
b) causing the pubic bone to engage the carrier and be moved to a predetermined position, in which the pubic bone is pressed up against the carrier and is held by it, and
c) conveying the ham by a second conveyor and an overhead conveyor for the carrier with the rind side lying on the second conveyor and the pubic bone pressed up against and held by the carrier to an area, where cuttings tools are arranged at these conveyors for the cutting of the ham.

2. A method according to claim 1, wherein the cutting tools perform one or more of the following:
d) separating the tailbone from the collarbone by means of a knife, which is moved in the transport direction of the conveyor and of the carrier during the separation,
e) undercutting the tailbone from the musculature of the ham by a rotatable curved knife, which is moved in the transport direction of the conveyor and of the carrier,
f) cutting off a fat edge in the transport movement by a knife, which is arranged one of stationarily or movably, and
g) gripping the groin meat by a gripper, which pulls the groin meat at the same time as a knife cuts the groin meat.

3. A method according to claim 1, wherein prior to the introduction into the first conveyor in a), conveying the hams on a conveyor belt with their cut face in parallel with the transport direction of the conveyor belt, and that, prior to the entry into the conveyor in a), turning the hams by a pawl, which is capable of assuming two positions and is moved perpendicularly inwards from the side of the conveyor belt, and which turns the hams so that their cut face will be disposed rearmost in the transport direction.

4. A method according to claim 1, and moving the carrier against a spring force upwards to a stop abutment in a predetermined, vertical position.

5. A method according to claim 1, wherein the carrier comprises a backstop part for contact with the upper side of the pubic bone, and a hanger part which holds the pubic bone transversely and rearwardly relative to the transport direction.

6. A method according to claim 1, and moving the carrier by means of one of a circulating chain conveyor, carriage or other conveyor in the same direction as the transport direction of the second conveyor, so that the ham is held between the second conveyor and the carrier while being transported to and through the cutting area.

7. A method according to claim 1, wherein the movement in b) to a predetermined position, in which the pubic bone is pressed up against the carrier, is established in that the ham is moved up an inclined introduction belt which is spring-loaded upwards by a greater force than the downwardly directed forces.

8. An apparatus for automatic cutting of a ham, comprising:
a) a first conveyor for supporting the ham on the rind side and conveying it inwards below a carrier for the pubic bone of the ham,
b) devices for engaging the pubic bone with the carrier and moving the pubic bone up to a predetermined position, in which the pubic bone is pressed up against the carrier and is held thereby, and
c) a second conveyor for supporting the ham on the rind side and an overhead conveyor for the carrier extending along the second conveyor, whereby cutting tools are arranged at an area of these conveyors.

9. An apparatus according to claim 8, wherein the carrier may be moved against a spring force upwards to a stop abutment in a predetermined, vertical position.

10. An apparatus according to claim 8, wherein the carrier comprises a backstop part for contact with the upper side of the pubic bone, and a hanger part which is adapted to hold the pubic bone transversely and rearwardly relative to the transport direction.

11. An apparatus according to claim 9, wherein the devices according to b) comprise an inclined introduction belt which is spring-loaded upwardly by a greater force than the force against which the carrier may be moved upwards to a predetermined position.

12. The method of claim 2, wherein the knife is mounted on a carriage.
